(19) United States
(12) Patent Application Publication
(10) Pub. No.: US 2012/0287630 A1
(43) Pub. Date: Nov. 15, 2012

(54) OPTICAL MODULE AND LIGHT-EMITTING DIODE LAMP

(75) Inventor: Chun-Heng Ou, New Taipei City (TW)

(73) Assignees: Kinpo Electronics, Inc., New Taipei City (TW); Cal-Comp Electronics & Communications Company Limited, New Taipei City (TW)

(21) Appl. No.: 13/433,277

(22) Filed: Mar. 28, 2012

(30) Foreign Application Priority Data
May 9, 2011 (TW) 100116168

(51) Int. Cl. F21V 5/04; F21V 7/00

(52) U.S. Cl. 362/235

(57) ABSTRACT

A light-emitting diode (LED) lamp includes a lamp holder, an optical module and a locking ring. The lamp holder has a first recess and the optical module is disposed in the first recess. The optical module includes a body, an LED board, a reflecting cover and a lens. The body has a second recess and the LED board is disposed in the second recess. The LED board includes a circuit board and a plurality of LEDs. The LEDs are disposed on the circuit board. The reflecting cover is disposed in the second recess and located on the LED board. The reflecting cover has a plurality of openings and the LEDs go through the corresponding openings to be exposed within the reflecting cover, and the lens is disposed at the reflecting cover. The locking ring is locked at the lamp holder to fix the optical module into the lamp holder.

### CROSS-REFERENCE TO RELATED APPLICATION

This application claims the priority benefit of Taiwan application serial no. 100116168, filed on May 9, 2011. The entirety of the above-mentioned patent application is hereby incorporated by reference herein and made a part of this specification.

### BACKGROUND OF THE INVENTION

1. Field of the Invention

The invention generally relates to an optical module and a light-emitting diode (LED) lamp, and more particularly, to an optical module and an LED lamp having higher luminance than convention.

2. Description of Related Art

LEDs belong to a semiconductor device, in which the material of light-emitting chips mainly is compounds of chemical elements of groups III-V, for example, gallium phosphide (GaP) or gallium arsenide (GaAs) and the light-emitting principle thereof is based on converting electric energy into light energy. In more details, in an LED, by applying electrical current on the compound semiconductor thereof, the electrons and the holes are recombined so as to release excess energy in light form. Since an LED emits light not through heating or discharge so that the lifetime thereof can be long over a hundred thousand hours. In addition, LEDs further have advantages of fast response, small size, power-saving, low pollution, high reliability and adaptation for mass production, so that the LEDs have widespread application fields, such as light sources used in mega-size display board, traffic light, handset, light source of scanner or fax machine, and LED illumination lamp.

However, in the designs of current LED lamps, the light emitted from the LEDs disposed in a lamp, although it can be concentrated within a specific range by converging the light through a lens, still has some light loss, which results in a limited light utilization ratio. Hence, the manufacturers are eager to quest for how to effectively advance the luminance of LEDs.

### SUMMARY OF THE INVENTION

Accordingly, the invention is directed to an optical module able to increase luminance.

The invention is also directed to an LED lamp having higher luminance than convention.

To achieve the above-mentioned or other objectives, the invention provides an optical module including a body, an LED board, a reflecting cover and a lens, in which the body has a recess and the LED board is disposed in the recess. The LED board includes a circuit board and a plurality of LEDs, in which the LEDs are disposed on the circuit board. The reflecting cover is disposed in the recess and located on the LED board, in which the reflecting cover has a plurality of openings and the LEDs go through the corresponding openings to be exposed within the reflecting cover, and the lens is disposed at the reflecting cover.

In an embodiment of the present invention, the above-mentioned reflecting cover includes a bottom and a side-wall, in which the openings are located at the bottom and the side-wall surrounds the bottom and is leaned on a wall of the recess of the body, and the bottom and the side-wall are integrated formed into the reflecting cover.

In an embodiment of the present invention, the material of the above-mentioned reflecting cover is plastic material with high reflectance.

In an embodiment of the present invention, the inner surfaces of the above-mentioned bottom and side-wall of the reflecting cover are coated with a material layer or a metal layer with high reflectance.

In order to achieve the above-mentioned or other objectives, the invention also provides an LED lamp including a lamp holder, an optical module and a locking ring. The lamp holder has a first recess and the optical module is disposed in the first recess. The optical module includes a body, an LED board, a reflecting cover and a lens, in which the body has a second recess and the LED board is disposed in the second recess. The LED board includes a circuit board and a plurality of LEDs, in which the LEDs are disposed on the circuit board. The reflecting cover is disposed in the second recess and located on the LED board, in which the reflecting cover has a plurality of openings and the LEDs go through the corresponding openings to be exposed within the reflecting cover, and the lens is disposed at the reflecting cover. The locking ring is locked at the lamp holder so as to fix the optical module into the lamp holder.

In an embodiment of the present invention, the above-mentioned reflecting cover includes a bottom and a side-wall, in which the openings are located at the bottom and the side-wall surrounds the bottom and is leaned on a wall of the recess of the body, and the bottom and the side-wall are integrated formed into the reflecting cover.

In an embodiment of the present invention, the material of the above-mentioned reflecting cover is plastic material with high reflectance.

In an embodiment of the present invention, the inner surfaces of the above-mentioned bottom and side-wall of the reflecting cover are coated with a material layer or a metal layer with high reflectance.

Based on the above depiction, in an optical module and an LED lamp using the optical module of the invention, the employed reflecting cover is able to re-collect and guide the light emitted from the LEDs, wherein the light is unable to be collected by the lens, so as to increase the luminance of the optical module and the LED lamp using the optical module.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic exploded diagram of an optical module according to an embodiment of the invention.

FIG. 2 is a cross-sectional assembly diagram of the optical module of FIG. 1.

FIG. 3 is a schematic exploded diagram of an LED lamp using the optical module of FIG. 1.

### DESCRIPTION OF THE EMBODIMENTS

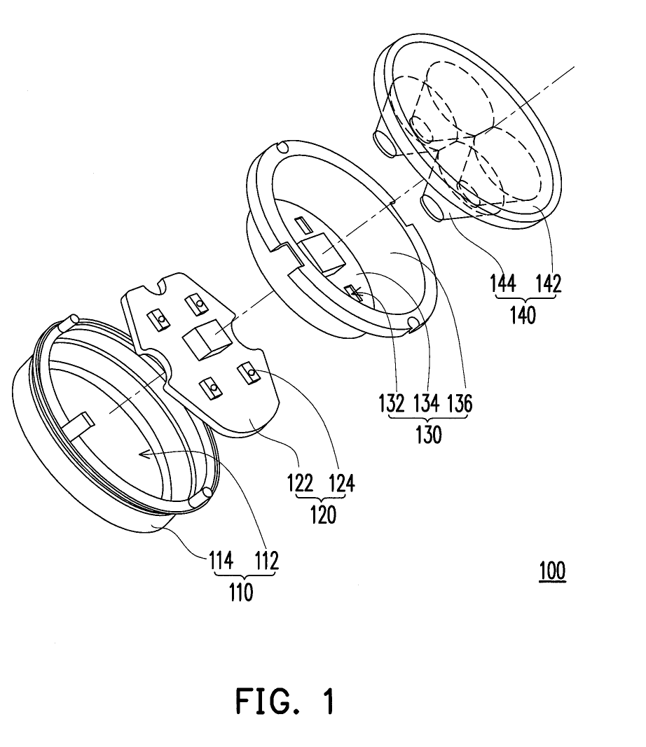

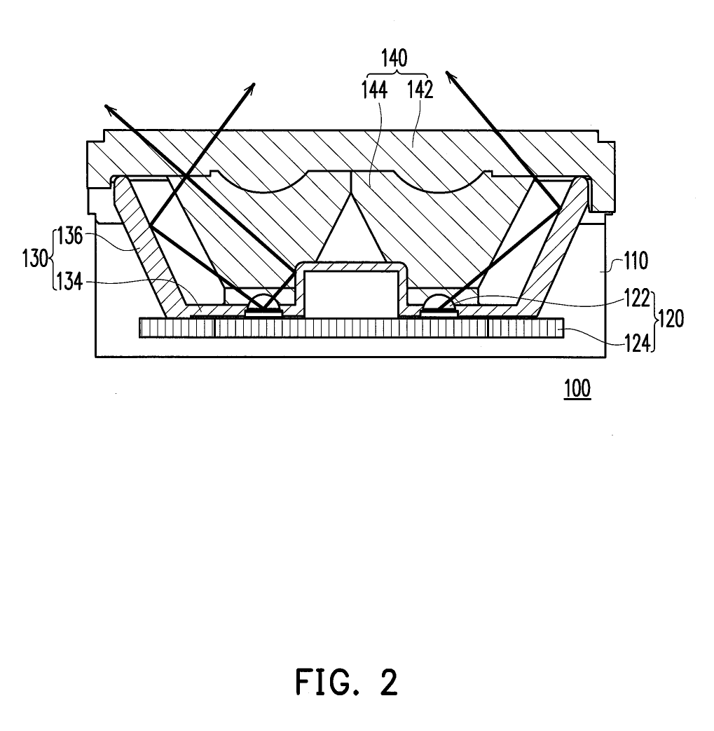

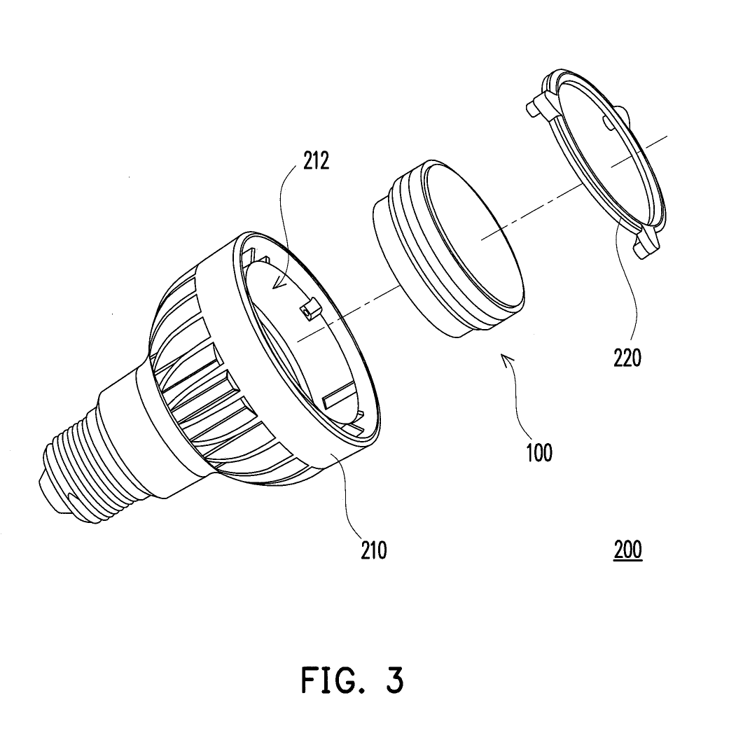

FIG. 1 is a schematic exploded diagram of an optical module according to an embodiment of the invention, FIG. 2 is a cross-sectional assembly diagram of the optical module of FIG. 1 and FIG. 3 is a schematic exploded diagram of an LED lamp using the optical module of FIG. 1. Referring to FIGS. 1-3, an LED lamp 200 includes a lamp holder 210, an optical module 100 and a locking ring 220. The lamp holder 210 has a first recess 212 and the optical module 100 is disposed in the first recess 212. The optical module 100 includes a body 110, an LED board 120, a reflecting cover 130 and a lens 140, in which the body 110 has a second recess 112 and the LED board 120 is disposed in the second recess 112. The LED board 120 includes a circuit board 122 and a plurality of LEDs 124, in which the LEDs 124 are disposed on the circuit board 122. The reflecting cover 130 is disposed in the second recess 112 and located on the LED board 120, in which the reflecting cover 130 has a plurality of openings 132 and the LEDs 124 go through the corresponding openings 132 to be exposed within the reflecting cover 130, and the lens 140 is disposed at the reflecting cover 130. The locking ring 220 is leaned on the lens 140 of the optical module 100, exposes out a lens body 142 of the lens 140 and is locked at the lamp holder 210 so as to fix the optical module 100 into the lamp holder 210.

The material of the lamp holder 210 in the embodiment is metal, and moreover, a plurality of fins (not shown) are disposed surrounding the first recess 212 so as to make the LED lamp 200 have good heat dissipation efficiency. In more details, the lamp holder 210 has multiple fins with heat dissipation effect, which effectively dissipate the heat accumulated in the lamp holder 210 so as to advance the heat dissipation effect and keep the LED lamp 200 with excellent illumination effect.

The reflecting cover 130 includes a bottom 134 and a side-wall 136, in which the openings 132 are located at the bottom 134 and the side-wall 136 surrounds the bottom 134. When the reflecting cover 130 is placed at the second recess 112, the side-wall 136 is leant on a wall 114 of the second recess 112 of the body 110. The reflecting cover 130 is fabricated according to the application demand, for example, the bottom 134 and the side-wall 136 are integrated formed into the reflecting cover 130, or the bottom 134 and the side-wall 136 are assembled together to form the reflecting cover 130.

The lens 140 includes a lens body 142 and a plurality of covers 144 in conic shape, in which the covers 144 can mantle the LEDs 124 thereon. By adjusting the optical path of the light emitted from the LEDs 124 through the shape of the covers 144, the light is emitted out from the lens body 142.

Although in the design of a usual LED lamp, a lens is employed to cover the LEDs, but even though the LEDs can be roughly categorized into a light source with directionality, the emitted light is affected by the shape and the material of the lens so that some portions of the light are unable to be emitted out of the lens as expected. In other words, the light emitted from the LEDs is unable to be completely and effectively utilized and has light loss. However, the optical module 100 in the embodiment employs the reflecting cover 130; in particular, the material of the reflecting cover 130 is plastic material with high reflectance, or inner surfaces (i.e., the surfaces towards the lens 140) of the bottom 134 and side-wall 136 of the reflecting cover 130 are coated with a material layer or a metal layer with high reflectance. In addition, the LEDs 124 after going through the openings 132 of the bottom 134 of the reflecting cover 130 are located within the reflecting cover 130 (i.e., within a space enclosed by the bottom 134 and the side-wall 136) so that the reflecting cover 130 is able to reflect the light emitted from the LEDs 124 after going through the lens 140 and diffused in the space of the second recess 112 of the body 110, and then the light is emitted out from the lens 140. In comparison with the usual design of an LED lamp, the number of lumen of the LED lamp 200 of the embodiment is effectively increased, which advances the integrated luminance of the LED lamp 200.

Table 1 shows a comparison of the numbers of lumina between an optical module of the embodiment and a conventional optical module.

TABLE 1

| | | | | Correlated | | | |
|---|---|---|---|---|---|---|---|
| | | | | Color | | | |
| | | | LUMEN, | Temperature, | | | increasing |
| optical module | | | Lm | CCT (k) | W | lm/W | effect |
| 1 | no reflecting cover | | 725.137 | 3060.77 | 17.589 | 41.2267 | — |
| | disposed | | 717.519 | 3061.61 | 17.426 | 41.1752 | |
| 5 | reflecting | embodiment 1 | 799.59 | 3033.27 | 17.504 | 45.6804 | 10.27% |
| | cover | embodiment 2 | 800.948 | 3033.39 | 17.373 | 45.2396 | 10.45% |
| | disposed | embodiment 3 | 795.97 | 3030.4 | 17.453 | 45.3773 | 9.77% |
| | | embodiment 4 | 803.12 | 3031.31 | 17.334 | 45.1783 | 10.75% |
| | | embodiment 5 | 792.741 | 3032 | 17.508 | 45.2788 | 9.32% |
| | | embodiment 6 | 804.973 | 3033.62 | 17.444 | 45.2863 | 11.01% |
| | | embodiment 7 | 797.911 | 3029.84 | 17.558 | 45.4443 | 10.04% |
| | | embodiment 8 | 795.314 | 3030.2 | 17.399 | 45.1356 | 9.68% |

It can be seen from Table 1 that the numbers of lumen of the optical module 100 employing the reflecting cover 130 is 10% in average higher than that of a conventional optical module without employing the reflecting cover 130. In other words, by employing the reflecting cover 130, the number of lumen of the optical module 100 is effectively advanced, which further increases the luminance of the LED lamp 200 using the optical module 100.

In summary, in an optical module and an LED lamp using the optical module of the invention, the employed reflecting cover with reflective effect is able to effectively collect and utilize the light emitted from the LEDs passing through the lens but not emitted out of the lens with expected angles. In this way, the invention can increase the number of lumen of the optical module and further the luminance of the LED lamp using the optical module.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An optical module, comprising:
a body, having a recess;
a light-emitting diode board, disposed in the recess and comprising a circuit board and a plurality of light-emitting diodes, wherein the light-emitting diodes are disposed on the circuit board;
a reflecting cover, disposed in the recess and located on the light-emitting diode board, wherein the reflecting cover has a plurality of openings and the light-emitting diodes go through the corresponding openings to be exposed within the reflecting cover; and
a lens, disposed at the reflecting cover.

2. The optical module as claimed in claim 1, wherein the reflecting cover comprises:
a bottom, wherein the openings are located at the bottom; and
a side-wall, surrounding the bottom, wherein the side-wall is leaned on a wall of the recess of the body.

3. The optical module as claimed in claim 2, wherein the bottom and the side-wall are integrated formed into the reflecting cover.

4. The optical module as claimed in claim 1, wherein the material of the reflecting cover is plastic material with high reflectance.

5. The optical module as claimed in claim 1, wherein inner surfaces of the bottom and side-wall of the reflecting cover are coated with a material layer or a metal layer.

6. A light-emitting diode lamp, comprising:
a lamp holder, having a first recess;
an optical module, disposed in the first recess and comprising:
a body, having a second recess;
a light-emitting diode board, disposed in the second recess and comprising a circuit board and a plurality of light-emitting diodes, wherein the light-emitting diodes are disposed on the circuit board;
a reflecting cover, disposed in the second recess and located on the light-emitting diode board, wherein the reflecting cover has a plurality of openings and the light-emitting diodes go through the corresponding openings to be exposed within the reflecting cover; and
a lens, disposed at the reflecting cover; and
a locking ring, locked at the lamp holder so as to fix the optical module into the lamp holder.

7. The light-emitting diode lamp as claimed in claim 6, wherein the reflecting cover comprises:
a bottom, wherein the openings are located at the bottom; and
a side-wall, surrounding the bottom and leaned on a wall of the second recess of the body.

8. The light-emitting diode lamp as claimed in claim 7, wherein the bottom and the side-wall are integrated formed into the reflecting cover.

9. The light-emitting diode lamp as claimed in claim 6, wherein the material of the reflecting cover is plastic material with high reflectance.

10. The light-emitting diode lamp as claimed in claim 6, wherein inner surfaces of the bottom and side-wall of the reflecting cover are coated with a material layer or a metal layer.
